(19) United States
(12) Patent Application Publication
(10) Pub. No.: US 2017/0082029 A1
(43) Pub. Date: Mar. 23, 2017

(54) GAS TURBINE, IN PARTICULAR A JET ENGINE

(71) Applicant: Ingenieurburo CAT M. Zipperer GmbH, Staufen (DE)

(72) Inventor: Markus Zipperer, Eschbach (DE)

(73) Assignee: Ingenieuburo CAT M. Zipperer GmbH, Staufen (DE)

(21) Appl. No.: 15/267,444

(22) Filed: Sep. 16, 2016

(30) Foreign Application Priority Data
Sep. 18, 2015 (DE) 102015011959.1

(51) Int. Cl. F02C 7/275; F02C 3/04; F02C 7/32

(52) U.S. Cl. CPC F02C 7/275; F02C 7/32; F02C 3/04

(57) ABSTRACT

The invention relates to a gas turbine (10), in particular a jet engine, comprising an intake (11), which supplies air to a compressor (12) for burning with a fuel, whereby a propulsion jet can be produced by the gas turbine, the compressor (12) being arranged on a shaft (15) of the gas turbine (10) for rotation therewith, and comprising a starter arrangement, which has an auxiliary unit (20) designed as an electrical starter/generator, which starts the turbine (10) and drives the compressor (12) by way of the shaft (15) until a minimum rotational speed is reached, a coupling means (30) being provided between an output-side shaft (25) of the auxiliary unit (20) and the shaft (15) of the gas turbine (10) as respective parts to be coupled, which coupling means (30) couples the parts to be coupled contactlessly. It is characteristic of the present invention that one of the parts to be coupled is designed as a magnetic disk (35) with a plurality of magnets (38) and the other part to be coupled is designed as a driver disk (32) of a metal with high electrical conductivity, so that a relative movement of the magnetic disk (35) with respect to the electrically conductive driver disk (32) allows the effect of inducing in the driver disk (32) eddy currents that produce magnetic fields opposed to the outer magnetic field and as a result produce a force effect between the magnetic disk (35) and the driver disk (32).

### BACKGROUND

The invention relates to a gas turbine, in particular a jet engine, comprising an intake, which supplies air to a compressor for burning with a fuel, whereby a propulsion jet can be produced by the gas turbine, the compressor being arranged on a shaft of the gas turbine for rotation therewith, and comprising a starter arrangement, which has an auxiliary unit designed as an electrical starter/generator, which starts the turbine and drives the compressor by way of the shaft until a minimum rotational speed is reached, a coupling means being provided between an output-side shaft of the auxiliary unit and the shaft of the gas turbine as respective parts to be coupled, which coupling means coupling the parts to be coupled contactlessly.

Starter arrangements are known and are widely used, for instance for starting small gas turbines, for example on aeronautical propulsion systems for models or drones. They accordingly are used as starters for the engine concerned, the starting of which takes place by blowing in air, for instance by compressed air that is especially to be provided for this purpose or by a blower. This is unsatisfactory to the extent that either only a limited amount of compressed air has to be provided, usually in containers that are difficult to handle, or else the blower that is used for producing the accelerated air impairs the function of the turbine per se as result of its positioning in front of the inlet.

There are known propulsion systems that are for starting but are also coupled to the shaft of the turbine, for example in the form of a starting turbine that is provided especially for this purpose and coupled by way of a transmission or else in the form of smaller internal combustion engines. Finally, also known for this are electrical drives that are coupled to the turbine shaft. All of these propulsion systems require the provision of an energy source, for instance an electrical-energy-storing storage means in the form of a rechargeable battery or fuel in the case of an internal combustion engine. Depending on the loading to which the power unit is subjected, a not inconsiderable effort must be expended for this.

In the case of the propulsion systems mentioned, a compressor arranged on the shaft of the gas turbine for rotation therewith is driven by the auxiliary unit and rotates with the shaft of the gas turbine. The output side of the auxiliary unit and the shaft of the turbine, as respective parts to be coupled, are coupled by a coupling means, so that a driving moment can be transmitted from the auxiliary unit to the turbine shaft.

After igniting the air-fuel mixture in a combustion chamber of the turbine and beginning the production of the propulsion jet, this process continues automatically and the shaft correspondingly continues to rotate. Without having to give it specifically, the minimum achievable rotational speed up to which the shaft of the turbine can be driven by the auxiliary unit can be qualified to the extent that the shaft must in any case be able to move independently by means of its combustion process.

The coupling of the auxiliary unit to the turbine shaft, which is entirely satisfactory with regard to the handling flexibility and speed endurance, does however most certainly entail problems, since, with a rigid coupling, the output shaft of the auxiliary unit rotates along with the turbine at a very high speed during operation following the starting process. In the case of the applications mentioned, these units may well achieve numbers of revolutions of their turbine wheels of the order of magnitude of 100,000 rpm to 250,000 rpm. It has been attempted to counteract this by connecting and disconnecting the parts to be coupled by a clutch that can be engaged and disengaged by an axial movement. This involved providing a coupling sleeve with an exchangeable O-ring, a system that is known as a Bendix coupling.

Even these rigid coupling systems that can be connected and disconnected by means of a coupling operation are not easy to handle, since the motor of the auxiliary unit and its output shaft require suitable cooling and their bearings require appropriate lubrication, and furthermore their service life is limited. With rigid coupling of the parts to be coupled, problems also occur in terms of vibrations, resonances and wearing of coupling parts. Moreover, the sensitivity to axial and angular offset results in stringent requirements being necessary for the highly precise alignment of the axes of the turbines and the auxiliary unit shaft. Finally, the disconnecting and connecting coupling with the O-ring is sensitive to contaminants and wear.

US 2013/0038057 A1 already discloses a gas turbine of the type mentioned at the beginning that is designed as a turbo-propeller gas turbine. The already known gas turbine has an engine unit, which comprises a low-pressure compressor, a high-pressure compressor, a combustion chamber, a high-pressure turbine and a low-pressure turbine, which are arranged one after the other in the axial direction. Arranged downstream of the low-pressure turbine in the direction of flow is a propeller. Provided on the inflow side of the low-pressure compressor is a starter arrangement, which has an auxiliary unit which is designed as a starter motor and in a first operating mode starts the already known gas turbine by way of the low-pressure compressor, in order in a second operating mode to serve as a power generator during the operation of the already known gas turbine. Provided here between the output-side shaft of the auxiliary unit and the shaft of the gas turbine as respective parts to be coupled is a coupling means, which in an appropriate way that is not stated any more specifically in US 2013/0038057 A1 can also couple the parts to be coupled contactlessly.

US 2010/0127496 A1 already discloses a gas turbine with a starter arrangement which comprises magnets in an annular zone provided on a compressor blade that are in electromagnetic operative connection with coils in a force transmission ring when the gas turbine is intended to be started.

Starter arrangements for gas turbines in which a power transmission between an electrical starter motor and the gas turbine is intended to take place by way of a coupling means of which the parts to be coupled are in electromagnetic operative connection have the disadvantage however that, in cases of greatly diverging speeds and in particular if the starter motor rotates at greater speeds in comparison with the gas turbine in the initial phase of the starting process, a breakaway of the magnetic force exerted between the corresponding magnets can occur, as a result of which excessive slip is produced. By contrast, when the gas turbine picks up speed, it will very quickly reach significantly higher speeds—speeds however that the electrical starter motor can never reach.

WO 2015/137814 A1 already discloses a magnetic coupling arrangement that can be used for example also as an eddy current brake. The already known magnetic coupling arrangement has two coupling disks, which are adjustable in relation to one another on a disk axis arranged coaxially in relation to the axes of rotation of the coupling disks. While one of the coupling disks carries permanent magnets, the other coupling disk is produced from an electrically conductive material. A specific use of the already known magnetic coupling arrangement with its coupling disks that are adjustable axially in relation to one another is not however mentioned any more specifically in WO 2015/137814 A1 and, on account of the comparatively great axial longitudinal extent of this already known magnetic coupling arrangement, its use is limited to those cases that allow a comparatively great longitudinal extent of such a magnetic coupling unit.

### SUMMARY

It is therefore the object of the present invention to develop a gas turbine, and in particular a jet engine, of the type mentioned at the beginning with a starter arrangement in which the aforementioned disadvantages are avoided and that in this way a starter arrangement that is robust and can be handled well is made available in the gas turbine according to the invention.

This object is achieved in the case of the gas turbine of the type mentioned at the beginning by one or more features of the invention. It is characteristic of the gas turbine according to the invention that one of the parts to be coupled is designed as a magnetic disk with a plurality of magnets and the other part to be coupled is designed as a driver disk of a metal with high electrical conductivity, so that a relative movement of the magnetic disk with respect to the electrically conductive driver disk allows the effect of inducing in the driver disk eddy currents that produce magnetic fields opposed to the outer magnetic field and as a result produce a force effect between the magnetic disk and the driver disk.

Provided in the gas turbine according to the invention is a starter arrangement, which has an auxiliary unit designed as an electrical starter/generator. With the starter arrangement provided according to the invention, an electrical starter/generator on the one hand provides an electrical propulsion for the starting of the gas turbine that can be managed well and in particular can be controlled. In an operating mode as a generator, it is at the same time capable after the starting of the gas turbine of using the coupling with the turbine shaft to recharge the storage means previously feeding it. At the same time, it is provided according to the invention to couple the parts to be coupled contactlessly by way of the coupling means, so that then the output side of the auxiliary unit and the turbine shaft are contactlessly in engagement. As a result, the auxiliary unit and the power unit are permanently mechanically decoupled, so that problems with vibrations, alignments, wear and contamination are effectively avoided.

In order to be able to couple the parts to be coupled contactlessly in a suitable way, and thereby be able to impart the driving moment produced by the auxiliary unit to the turbine shaft with little loss, the coupling means transmits a driving moment of the auxiliary unit to the shaft of the turbine by a contact-free field force, the field force being in particular a magnetic field force. Magnetic forces exerted by one of the parts to be coupled are capable of contactlessly coupling the other part to be coupled in a suitable way and passing on to the latter an exerted moment. In principle, it is of no importance here from which of the parts the magnetic force comes, but only that in the presence of a magnetic field a movement of the one part is transferred to the other, respectively.

It is in this case characteristic of the gas turbine according to the invention that one of the parts to be coupled of its starter arrangement is designed as a magnetic disk with a plurality of magnets and the other part to be coupled is designed as a driver disk of a metal with high electrical conductivity, so that a relative movement of the magnetic disk with respect to the electrically conductive driver disk allows the effect of inducing in the driver disk eddy currents that produce magnetic fields opposed to the outer magnetic field and as a result produce a force effect between the magnetic disk and the driver disk.

This is based on the fact that, when there is movement of a metal object in an inhomogeneous outer magnetic field, here that is in relation to the annular arrangement of magnets, a current and resultant eddy currents are induced in the driver disk. These eddy currents in turn produce magnetic fields opposed to the outer magnetic field, so that a force effect occurs between the magnetic disk and the driver disk. A relative movement of the magnetic disk with respect to the conductive driver disk has the same effect; what is decisive here is not the magnetizability of the driver disk, but just its electrical conductivity. Good results are achieved with disks of copper or aluminum, but other materials are also conceivable.

The two disks of the coupling means that form the parts to be coupled, and indeed are not in contact, therefore form a kind of eddy current coupling between the auxiliary unit and the turbine. In principle, neither of the two arrangements is preferred here; it is therefore actually all the same whether for example the magnetic disk forms the part to be coupled that is assigned to the auxiliary unit or forms the part to be coupled that is assigned to the turbine shaft. On account of the thermal conditions in the vicinity of the turbine, however, an arrangement with the magnetic disk on the output side of the auxiliary unit is to be preferred.

Therefore, in a development of the starter arrangement, the magnetic disk may be advantageously provided with an annular arrangement of electromagnets or permanent magnets with alternating pole arrangement, in the case of permanent magnets these being formed in particular as neodymium magnets. The eddy current coupling formed by the parts to be coupled is therefore formed by a disk with a multipolar-magnetized magnet, which is opposite a disk with good electrical conductivity, for example a copper disk, and spaced apart from it by a gap. The magnet and the driver disk are respectively connected on the rear side to iron disks of the same diameter. The transmittable driving moment is in this case dependent on the dimensioning of the disks, the material of the magnet, the number of poles, the air gap and the relative rotational speed. The higher the speed, the higher the transmittable or transmitted driving moment or torque. The flux occurring, and consequently the moment, would in this case necessarily be possible for instance by axial displacement, that is to say changing of the air gap. Merely as examples and without restricting the generality, values of the parameters mentioned may be in the case of the number of pairs of poles between 8 and 16, for example 12, the surface area of the disks with a diameter of several 10 mm, for example 20 mm, and the gap between the disks several tenths of a millimeter, for example 1/10 mm. Which values individual parameters should take depends primarily on the demand on the motor in starter operation, in which the motor has to be set to a rotational speed for driving the gas turbine from the voltage available by way of the driver disk and the turbine shaft, which may well be several 10,000 revolutions, for example 40,000 revolutions/minute.

In another expedient development of the starter arrangement, in which the magnets can be provided particularly well in their annular arrangement, and in such a way a magnetic disk can be easily realized, the magnetic disk may have a carrier with a number of receptacles corresponding to the number of magnets, in which the magnets are accommodated, in particular with the receptacles extending through the carrier in the axial direction. The clearances, and correspondingly the magnet, may in this case preferably have a cylindrical shaping. However, other shapes, for example similar to sectors of a circle, are also conceivable. The carrier is in this case not provided in a magnetic form.

In another development of the starter arrangement, the magnetic disk may preferably be provided here with an annular arrangement of electromagnets or permanent magnets with alternating pole arrangement, it being possible in the case of permanent magnets for these to be formed in particular as neodymium magnets.

Another advantageous configuration forms a starter arrangement in which the magnetic disk is connected on its side facing away from the other part to be coupled to a soft-magnetic disk of the same diameter. The soft-magnetic disk in this case forms the magnetic return of the coupling side concerned and moreover is also capable of shielding the permanent magnets. It is used as a soft-magnetic disk because the temporary magnetization that it is exposed to by the outer magnetic field should not lead to permanent magnetization. In the same way, such a soft-magnetic disk may also be formed on the side of the driver disk that is facing away from the magnetic disk, or be connected to it. Such a disk may be formed for example from a soft-iron alloy. In order to produce an improved mechanical connection with this disk, and moreover to keep permanent magnets reliably in their receptacles, an adhesive, for example a structural adhesive, should be additionally used.

In another advantageous form, in which the driver disk can form a component part of the coupling in an easy way, the driver disk is arranged in the position for use on the starter arrangement in a receptacle that is arranged at the end of the turbine shaft that is facing the propulsion system. The receptacle concerned is in this case preferably provided at the end face on a shaft nut that secures the compressor in an axially fixed manner. Particularly preferably, the receptacle mentioned may in this case enclose the driver disk with its edge.

In order to be able to use the free, drivable end of the turbine shaft in an easy way as a point for arranging one of the parts to be coupled, in the case of a development of the starter arrangement the shaft nut and the driver disk are held on the end of the turbine shaft for rotation therewith by a common securing means. The securing means may in this case be formed by a screw, which passes through the shaft nut and the driver disk respectively at a coaxial opening. Other securing means are also conceivable. As already mentioned, the magnetic disk may also be arranged on the shaft nut and in principle on the free end of the turbine shaft that is facing the auxiliary unit.

In a particularly advantageous embodiment, in which the electrical energy necessary for operating the starter motor can be recovered, in the case of the starter arrangement according to the invention the auxiliary unit can be operated as a motor and as a generator, it being possible in particular to achieve a changeover between motor operation and generator operation without switching means.

The auxiliary unit is then an electrical machine that converts kinetic energy back into electrical energy. The generator is practically the counterpart of the drive motor of the auxiliary unit that had converted electrical energy into kinetic energy of the turbine.

The parts to be coupled of the coupling means are “softly” coupled by the eddy current coupling, since the coupling means does not form a rigid mechanical coupling of the component parts. In generator operation, the magnetic disk is the driven part, which as a result of the “soft” coupling is capable of slipping, whereby the rotational speed of the motor shaft, dependent on the turbine speed of the other part to be coupled, sets itself. The eddy current coupling has to a certain extent a slipping clutch effect.

If the generator voltage corresponds to or exceeds the voltage at the time of the storage means for motor operation, this has the effect that a current flow takes place counter to the feeding direction, the generator current that is flowing back being proportional to the rotational speed of the generator or its output-side shaft.

In a preferred development of the starter arrangement according to the invention, the auxiliary unit is formed by a brushed electric motor or by a three-phase synchronous machine, in particular a three-phase BLDC motor. In motor operation, which is of course the operating mode as a starter and in which the turbine shaft rotates at a lower rate than the generator shaft, the three motor phases are commutated by way of a controller in such a way that the motor is set in rotation. In this mode, the turbine is started while the charging system is deactivated.

In generator operation, in which the output-side shaft of the auxiliary unit rotates at a lower rate than the turbine shaft, the voltage induced in the motor phases is rectified by a current rectifying means, so that a charging current can be passed to the storage means of the starter arrangement. The previously described motor commutation for starting operation is deactivated in this operating mode.

The operation as a motor and a generator also works when using the brushed motor; in this case it is possible to dispense with the previously mentioned current rectifying means and electronic devices for commutating the motor, since in the case of a brushed motor these functions are undertaken by its collector, which with its sliding contacts provides a change of the polarity. This alternative may be of interest, and in particular less costly, in particular in the case of uses in which only a short service life is required.

An expedient development of the starter arrangement according to the invention, which provides the greatest possible distance between the coupling means and the combustion process, and also the turbine wheel driven by the latter, provides the coupling means at the compressor-side end of the shaft; in particular, the auxiliary unit may in this case be arranged with its end face in the region of the intake of the turbine/turbine shaft. With this positioning, the latter benefits in particular in terms of thermal advantages and a short coupling distance.

In order to secure the auxiliary unit captively on the power unit in a suitable way, and at the same time not adversely influence either the contour of the power unit or the air access to the compressor, in the case of a further embodiment of the starter arrangement a plurality of struts that carry the auxiliary unit may be provided at an opening of the turbine casing that forms the intake of the turbine, the struts projecting inwardly in the direction of a longitudinal axis of the power unit, in particular projecting inwardly in a curved manner, and arranged spaced apart on an edge of the opening, in particular arranged spaced apart at equal angular intervals. In this case, the longitudinal axes of the power unit and the auxiliary unit are preferably arranged coaxially in relation to one another. Furthermore, the auxiliary unit may be accommodated by a housing for its protection.

A development of the starter arrangement may be that along at least one of the struts there extend electrical connecting means, which provide motor current at the phases of the auxiliary unit or take off generator current at the phases of the auxiliary unit. Furthermore, at the end of the auxiliary unit that is facing away from the shaft of the turbine, the phase terminals of the auxiliary unit may be led to the outside.

The operation of the auxiliary unit in different modes is expediently assisted by an embodiment of the starter arrangement in which the auxiliary unit is assigned at least one control means of the starter arrangement that controls the commutation of the auxiliary unit in motor operation and/or controls the charging of at least one electrical storage means that is connected to the auxiliary unit and can be charged in generator operation of the auxiliary unit.

The previously presented object is also achieved by a method for operating a starter arrangement on a gas turbine or a similar power unit, for example on a jet engine, in particular by a starter arrangement as described above, a coupling means being provided between an output side of the auxiliary unit and a shaft of the power unit as respective parts to be joined. The method according to the invention is distinguished in particular by the following method steps, specifically

contactlessly coupling an output side of the auxiliary unit to a shaft of the power unit
starting the power unit by the auxiliary unit as an electrical drive
reaching a minimum rotational speed of the power unit
changing over the operation of the auxiliary unit to generator operation without switching means
charging at least one electrical storage means with a charging current by way of a control means.

In this way, for instance, a gas turbine as a power unit can be started in an advantageous way by being brought to a minimum rotational speed by an auxiliary unit working in motor operation, after which, when the rotational speed of the turbine shaft exceeds that of the auxiliary unit shaft, the auxiliary unit is operated in generator mode and as a result the storage means supplying it with energy is recharged. The coupling means, which is robust because it is contactless, is not rigid and avoids a switching means for generator operation that is provided especially for this purpose, since the rotational speed at a shaft of the generator sets itself.

In the case of a variant of the method, the final charging voltage of the storage means of the generator can be manipulated in an easy way by the control means producing a control signal by means of which an electrical switching means, for example a transistor, is pulse-width-modulated.

### BRIEF DESCRIPTION OF THE DRAWINGS

The invention is explained in more detail below on the basis of exemplary embodiments in the partly schematic drawing, in which:

FIG. 1 shows a planar end-on view of a first exemplary embodiment of the starter arrangement from the side of the inlet into the turbine with an auxiliary unit arranged in front of the compressor;

FIG. 2 shows a perspective side view of the power unit with the starter arrangement from FIG. 1;

FIG. 3 shows a perspective view of a starter arrangement from FIGS. 1 and 2 comprising a turbine shaft with a turbine wheel, a compressor, an auxiliary unit and a flare of the inlet;

FIG. 4 shows a perspective view of the starter arrangement from FIG. 3 from a different viewing angle, in which the flare of the inlet and the struts have been omitted;

FIG. 5 shows an exploded, planar side view of the starter arrangement from FIG. 4,

FIG. 6 shows an exploded, perspective side view of the starter arrangement from FIG. 5; and

FIG. 7 shows a basic diagram of the way in which an exemplary embodiment of the control means of a starter arrangement functions.

### DETAILED DESCRIPTION OF THE PREFERRED EMBODIMENTS

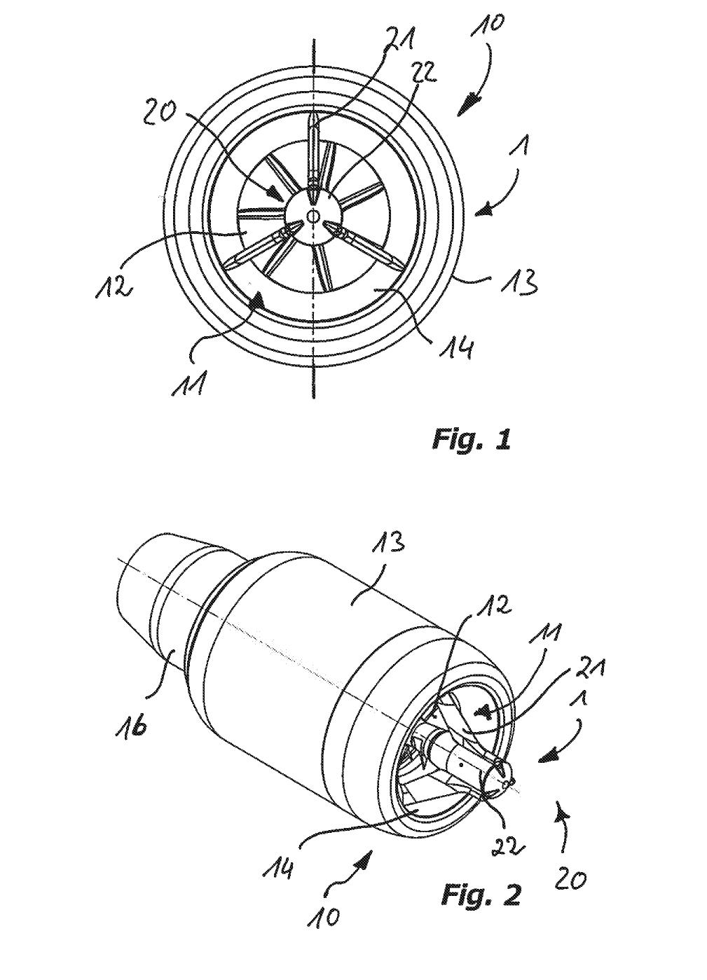

In FIGS. 1 to 6, a starter arrangement denoted as a whole by 1 can be seen on a power unit formed by a gas turbine 10. The gas turbine 10 has an intake 11, which supplies air to a compressor 12 for burning with a fuel, whereby a propulsion jet can be produced by the power unit. The compressor 12 is arranged on a shaft 15 of the turbine 10 for rotation therewith. The starter arrangement 1 has an auxiliary unit 20, which starts the turbine 10 and drives the compressor 12 by way of the shaft 15 until a minimum rotational speed is reached. A coupling means 30 is provided between an output-side shaft 25 of the auxiliary unit 20 and the shaft 15 of the turbine 10 as respective parts to be coupled. The auxiliary unit 20 is in this case designed as an electrical starter/generator, and the coupling means 30 couples the parts to be coupled contactlessly.

FIGS. 1 and 2 show here the gas turbine 10 comprising the starter arrangement 1 as a whole with a turbine casing 13, arranged at the end of which that is facing away from the starter arrangement 1 is a nozzle 16 for the outlet of the propulsion jet that is produced in the gas turbine 10 by way of a combustion process and is not represented any further. In FIG. 1, the viewer is looking end-on at the intake 11 of the gas turbine 10, which opens out into the compressor 12 and has a flare 14 tapering in the axial direction. Positioned in the intake is the auxiliary unit 20 of the starter arrangement 1, which is suspended with its housing 22 on three struts 21, spaced apart at equal angular intervals, in front of the compressor 12 in the viewing direction, the longitudinal axes of the gas turbine 10 and the auxiliary unit 20 being arranged coaxially in relation to one another. The struts 21 project from the edge of the opening of the flare 14 in the direction of the longitudinal axis and thereby away from the compressor 12.

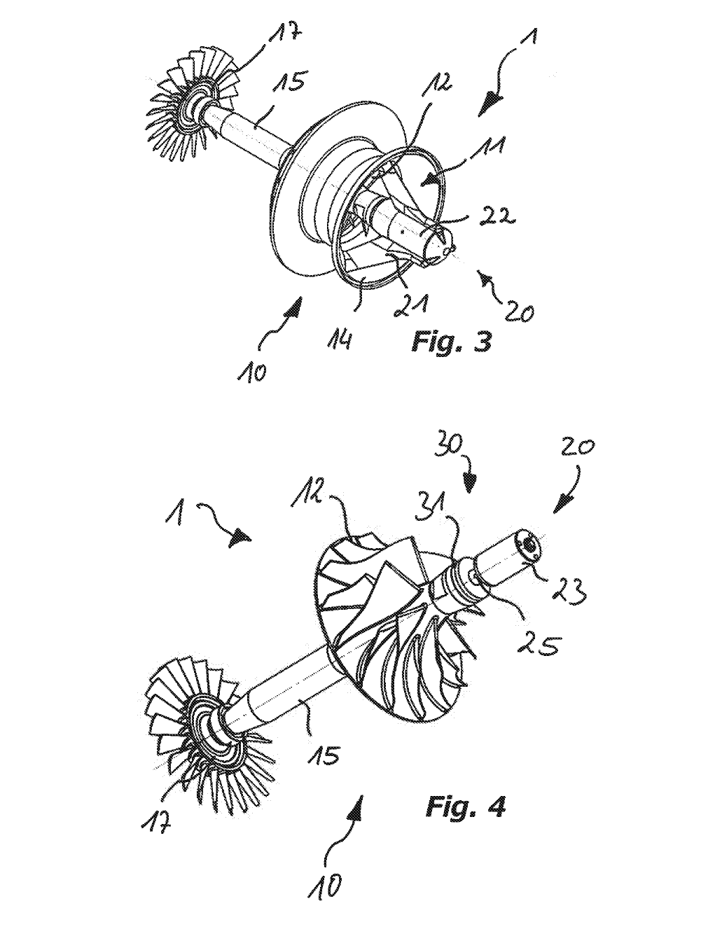

In FIG. 3, the same starter arrangement 1 can be seen, without the turbine casing 13, so that the turbine shaft 15 of the gas turbine 10 and also, at its end facing away from the compressor 12, the turbine wheel can be seen. Also shown in FIG. 3 are the struts 21, which are connected to the edge of the opening of the flare 14 and suspended on which is the auxiliary unit 20 accommodated in its housing 22.

By contrast with FIG. 3, the flare 14, the struts 21 and the housing 22 of the auxiliary unit 20 are not shown in FIG. 4, so that now the compressor 12, arranged on the turbine shaft 15 for rotation therewith and in an axially fixed manner, and also the BLDC motor 23 of the auxiliary unit 20 can be seen well. The coupling means 30, at which the turbine shaft 15 and the shaft 25 of the auxiliary unit 20 as parts to be coupled are coupled to one another contactlessly, and therefore softly, and at the same time are separated by the gap 31, can now also be seen.

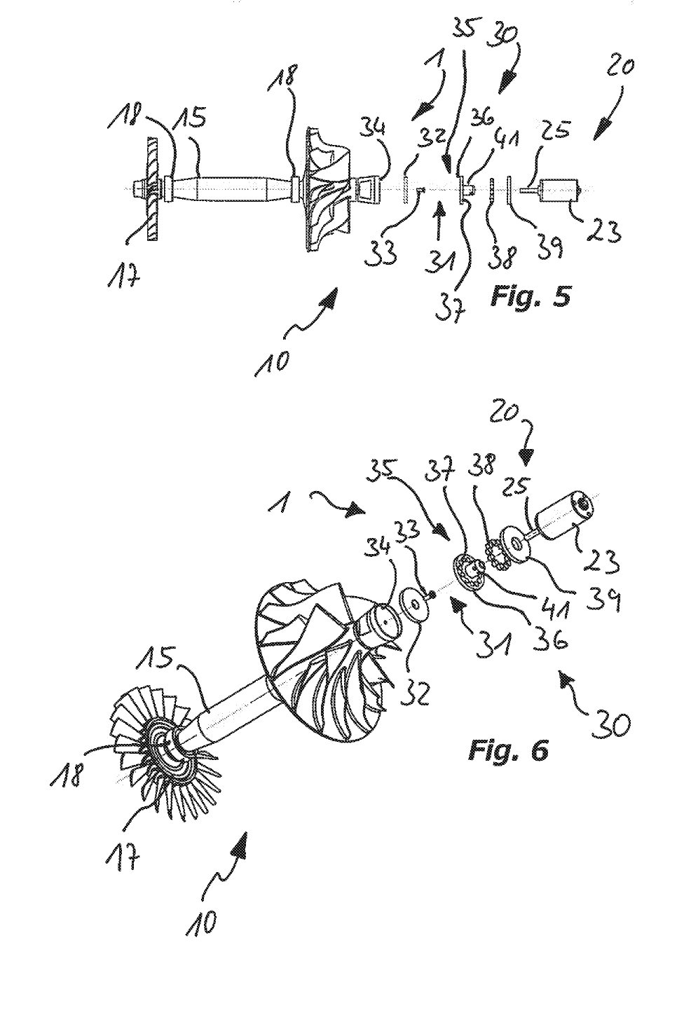

FIGS. 5 and 6 show well in particular the contact-free coupling of the parts to be coupled of the coupling means 30, which due to the exploded representation is readily understandable. Respectively beginning on the side that is on the left for the viewer, in the representations the turbine wheel 17 arranged at the end there of the turbine shaft 15 can be seen. On the turbine shaft 15 there can also be seen two bearing elements 18, on which the turbine shaft 15 is mounted. Between the right of the two bearing elements 18 and a shaft nut 19, the compressor 12 is arranged on the turbine shaft 15 in an axially fixed manner.

The coupling element 30 contactlessly connects the turbine shaft 15 and the output-side shaft 25 of the auxiliary unit 20, which forms the motor shaft of the BLDC motor 23, as parts to be coupled. Provided for this on the shaft nut 19 is a receptacle 34, which receives the driver disk 32. The driver disk 32 is held on the shaft nut 19 by a screw 33 as fastening means and is enclosed by the edge of the receptacle 34.

Spaced apart from the driver disk 32 by the gap 31, the other part to be coupled can be seen on the coupling means 30 in the form of the magnetic disk 35, which is formed by a non-magnetic magnet carrier 36, in the axial passages 37 of which twelve permanent magnets 38 are accommodated. The magnet carrier sits with a flange 41 on the output-side shaft 25 of the auxiliary unit 20 and is secured there for rotation therewith. Coming from the direction of the gap 31, arranged behind the magnet carrier 36 is a return disk 39, with the same two-dimensional extent as the magnet carrier 36, of a soft iron alloy.

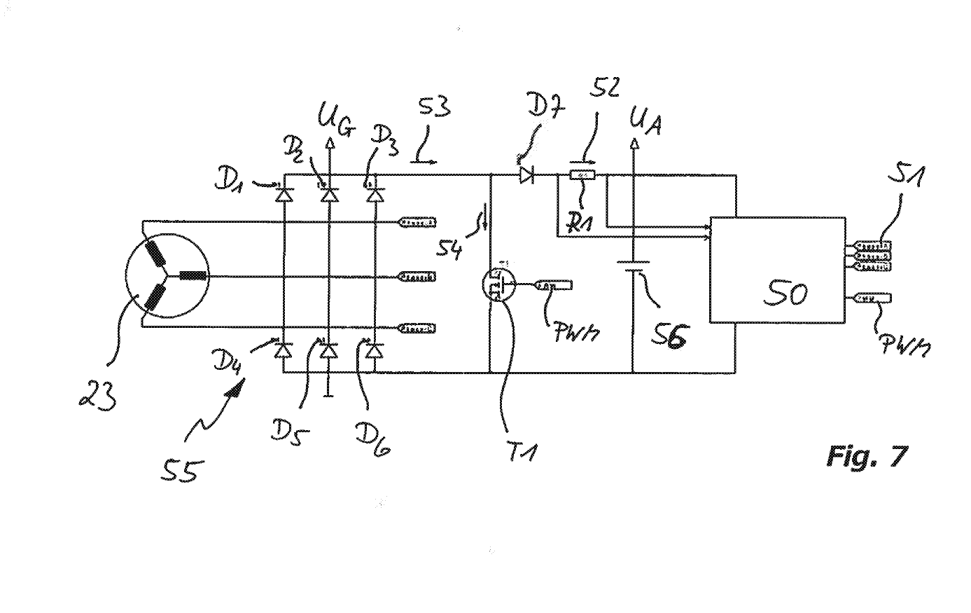

In FIG. 7, a basic diagram on the basis of which the operating modes of the auxiliary unit 20 can be explained well can be seen. In the diagram, the motor/generator 23 of the starter arrangement 1 can be schematically seen. In motor operation/starter operation, the turbine shaft 15 of the gas turbine 10 rotates at a lower rate than the output-side shaft 25 of the auxiliary unit 20 with the motor 23, which commutates the three motor phases by way of the controller 50 with commutating signals 51 in such a way that the motor 23 is set in rotation, whereby the turbine 10 can be started. The charging function of generator operation is in this case not functioning, there is no PWM signal.

Once the turbine 10 has been started, the motor 23 can be operated in generator operation. In generator operation, in which the output-side shaft 25 of the auxiliary unit 20 as the generator shaft is rotated at a lower rate than the turbine shaft 15, the voltage induced in the motor phases is rectified by a diode network 35, formed of six diodes D1 to D6. The motor commutation described above by means of commutation signals 51 for starter operation is deactivated in this operating mode.

As soon as the rectified voltage UG is greater than the voltage UA of the electrical storage means 56 designed as a rechargeable battery, the charging current symbolized by the arrow 52 begins to flow by way of the diode D7 and the shunt R1 into the storage means 51.

The control of the final charging voltage of the storage means 51 and the limitation of the maximum charging current take place solely by way of the pulse-width-modulated control signal PWM that is produced by the control means 50 and pulse-width-modulates a transistor T1. If the charging current and/or the rechargeable battery voltage become too great, the duty cycle of the control signal PWM is increased slowly by way of the controller 50 from zero by means of a PI controller of the control means 50 that is not represented any further. As a result, part of the generator current symbolized by the arrow 53 is discharged by way of the transistor T1 by the control current symbolized by the arrow 54.

The following two things happen as a result: firstly, there is a reduction in the charging current into the storage means 56 and secondly there is a slight drop in the rotational speed of the generator (motor) 23, since the eddy current coupling of the coupling means 30 develops more slip as a result of the altogether increased current loading of the generator 23. An increased motor current means a greater torque, which in turn increases the slip of the coupling means, whereby the rotational speed of the generator 23 then falls

In an extreme case, if the control signal PWM has been set to 100%, which would be tantamount to a shorting of the generator 23, the rotational speed of the generator 23, and consequently also its output voltage, would drop to very low values, the rotational speed to a few revolutions. Although a constant current would still flow by way of the transistor T1 and the motor windings, there would altogether be very small power losses, since the motor voltage and the rotational speed would settle at almost zero as a result of the short-circuit operation.

This is attributable to the slipping clutch effect of the coupling means 30 as an eddy current coupling. At the operating point just described, no charging current would then flow any longer into the storage means 56, and moreover the generator/motor 23 in particular would be relieved of stress with respect to its mounting, since it runs with only a few revolutions. What then becomes warmer at this operating point is the copper driver disk 32 on the turbine shaft 15; however, this is in any case always extremely cooled by the air stream into the turbine 10 as a result of the air speeds in the intake of the turbine 10 in the range of several hundred km/h.

The invention described above accordingly relates to a starter arrangement 1 on a gas turbine 10 or a similar power unit, for example on a jet engine, comprising an intake 11, which supplies air to a compressor 12 for burning with a fuel, whereby a propulsion jet can be produced by the power unit, the compressor 12 being arranged on a shaft 15 of the turbine 10 for rotation therewith, and comprising an auxiliary unit 20, which starts the turbine 10 and drives the compressor 12 by way of the shaft 15 until a minimum rotational speed is reached. In this case, a coupling means 30 is provided between an output-side shaft 25 of the auxiliary unit 20 and the shaft 15 of the turbine 10 as respective parts to be coupled. In order to make a starter arrangement 1 that is robust and can be handled well available, according to the invention the auxiliary unit 20 is in this case designed as an electrical starter/generator, and the coupling means 30 couples the parts to be coupled contactlessly.

In comparison with known coupling possibilities, which with a rigid coupling have to allow the parts to be coupled to run at the same rotational speed, a robust and soft coupling of the parts to be coupled is thus provided and at the same time charging of an energy storage means in generator operation of the auxiliary unit 20 is made possible.

Several advantages are obtained as a result. This is so because, with the comparatively low rotational speeds achieved by the auxiliary unit 20 during operation, the starter arrangement 1 according to the invention is unproblematic with regard to its service life, and cooling and lubrication can be easily realized. Moreover, problems that occur with rigid, mechanical coupling, such as vibrations, resonances or wearing of a disconnecting coupling, are avoided. The starter arrangement 1 according to the invention is also not sensitive to the axial offset/angular offset of the turbine shaft 15 and the output-side shaft 25 of the auxiliary unit 20, that is to say the motor/generator shaft, so that it is possible to dispense with a highly precise alignment of the two axes. Moreover, it is also not sensitive to contamination. Moreover, it is possible to dispense with switched-mode power supplies or to dispense with DC converters for charge control, so that savings can be made in terms of its space requirement/weight/costs and no interference emission takes place from the converter. The charge control can take place by means of a transistor T1. The starter arrangement 1 also functions even in the case of extremely high rotational speeds of the turbine shaft 15 of several 100,000 revolutions/minute and makes power generation/coupling of a generator 23 possible even in the case of extremely small turbines 15 and very high rotational speeds.

### LIST OF DESIGNATIONS

1 Starter arrangement
10 Gas turbine
11 Intake
12 Compressor
13 Turbine casing
14 Flare
15 Turbine shaft
16 Nozzle
17 Turbine wheel
18 Bearing element
19 Shaft nut
20 Auxiliary unit
21 Strut
22 Housing of auxiliary unit
23 BLDC motor/generator
25 Output-side shaft of the auxiliary unit
30 Coupling means
31 Gap
32 Driver disk
33 Screw
34 Receptacle
35 Magnetic disk
36 Magnet carrier
37 Receptacle for permanent magnets
38 Permanent magnet
39 Return disk of soft-iron alloy
41 Flange of the magnet carrier
50 Controller
52 Arrow as symbol of the charging current
53 Arrow as symbol of the generator current
54 Arrow as symbol of control current passed by way of transistor
55 Diode network
56 Electrical storage means
Dx Diode of the diode network
PWM Control signal
R1 Shunt
T1 Transistor

1. A gas turbine (10), comprising an intake (11) and a compressor (12), the intake (11) supplies air to a compressor (12) for burning with a fuel, whereby a propulsion jet is produced by the gas turbine, the compressor (12) being arranged on a shaft (15) of the gas turbine (10) for rotation therewith, and comprising a starter arrangement, which has an auxiliary unit (20) designed as an electrical starter/generator, which is adapted to start the turbine (10) and drive the compressor (12) by way of the shaft (15) until a minimum rotational speed is reached, a coupling element (30) provided between an output-side shaft (25) of the auxiliary unit (20) and the shaft (15) of the gas turbine (10) as respective parts to be coupled, said coupling element (30) couples the parts to be coupled contactlessly, wherein one of the parts to be coupled has a magnetic disk (35) with a plurality of magnets (38) and the other part to be coupled has a driver disk (32) of a metal with high electrical conductivity, so that a relative movement of the magnetic disk (35) with respect to the electrically conductive driver disk (32) induces in the driver disk (32) eddy currents that produce magnetic fields opposed to an outer magnetic field and as a result produce a force effect between the magnetic disk (35) and the driver disk (32).

2. The gas turbine as claimed in claim 1, wherein the magnetic disk (35) is assigned to the auxiliary unit (20) as the part to be coupled.

3. The gas turbine as claimed in claim 1, wherein the electrically conductive driver disk is produced from copper or from aluminum.

4. The gas turbine as claimed in claim 1, wherein the parts to be coupled are arranged in a position for use face-to-face with one another, and a movement of the one part to be coupled causes movement of the other part to be coupled.

5. The gas turbine as claimed in claim 1, wherein the magnetic disk (36) is provided with an annular arrangement.

6. The gas turbine as claimed in claim 1, wherein the magnetic disk (35) has a carrier (36) with a number of receptacles (37) corresponding to a number of the magnets (38), in which the magnets (38) are accommodated.

7. The gas turbine as claimed in claim 1, wherein the magnetic disk (35) is connected on a side facing away from the other part to be coupled to a soft-magnetic return disk (39) of a same diameter.

8. The gas turbine as claimed in claim 1, wherein the driver disk (32) is arranged in a position for use in a receptacle (34) that is arranged at an end of the turbine shaft (15) that is facing the propulsion system, the receptacle (34) being provided at an end face on a shaft nut (19) that secures the compressor (12) in an axially fixed manner.

9. The gas turbine as claimed in claim 8, wherein the shaft nut (19) and the driver disk (32) are held on the end of the turbine shaft (15) for rotation therewith by a common securing element means.

10. The gas turbine as claimed in claim 1, wherein the auxiliary unit (20) is operable as a motor and as a generator.

11. The gas turbine as claimed in claim 1, wherein the auxiliary unit (20) is formed by a brushed electric motor or by a three-phase synchronous machine.

12. The gas turbine as claimed in claim 1, wherein the coupling element (30) is provided at the compressor-side end of the turbine shaft (15).

13. The gas turbine as claimed in claim 1, wherein further comprising a plurality of struts (21) that carry the auxiliary unit (20) provided at an opening of a turbine casing (13) that forms the intake (11) of the turbine (10), the struts projecting inwardly in a direction of a longitudinal axis of the power unit, and are arranged spaced apart on an edge of the opening.

14. The gas turbine as claimed in claim 13, preceding claims, wherein along at least one of the struts (21) there extend electrical connectors, which provide motor current at phases of the auxiliary unit (20) or take off generator current at the phases of the auxiliary unit (20) or, at an end of the auxiliary unit (20) that is facing away from the shaft (15) of the turbine (10), the phase terminals of auxiliary unit are led to the outside.

15. The gas turbine as claimed in claim 1, wherein the auxiliary unit (20) is assigned at least one controller (50) of the starter arrangement (1) that controls a commutation of the auxiliary unit (20) in motor operation or controls a charging of at least one electrical storage device (56) that is connected to the auxiliary unit and is chargeable in a generator operation of the auxiliary unit (20).

16. A method for operating a starter arrangement (1) provided on a gas turbine as claimed in claim 1, wherein the coupling element is provided between the output side of the auxiliary unit (20) and the shaft (15) of the power unit as respective parts to be coupled, comprising the following method steps
contactlessly coupling the output side of the auxiliary unit (20) to the shaft (15) of the power unit (20);
starting the power unit (10) by the auxiliary unit (20) as an electrical drive;
reaching the minimum rotational speed of the power unit (10);
changing over operation of the auxiliary unit (20) to generator operation without a switching device; and
charging at least one electrical storage device (56) with a charging current by way of a controller (50).

17. The method as claimed in claim 16, wherein a control signal (PWM) by which an electrical switching element is pulse-width-modulated is produced by the controller (50).

18. The gas turbine as claimed in claim 5, wherein the permanent magnets are provided and are formed as neodymium magnets.

19. The gas turbine as claimed in claim 6, wherein the receptacles (37) extend through the carrier in an axial direction.

20. The gas turbine as claims in claim 1, wherein the auxiliary unit (10) is accommodated in a housing (22).
